(19) United States
(12) Patent Application Publication
(10) Pub. No.: US 2009/0273242 A1
(43) Pub. Date: Nov. 5, 2009

(54) Wireless Delivery of power to a Fixed-Geometry power part

(75) Inventor: Nigel P. Cook, El Cajon, CA (US)

Correspondence Address: Law Office of Scott C Harris Inc, PO Box 1389, Rancho Santa Fe, CA, 92067, US

(73) Assignee: Nigelpower, LLC, San Diego, CA (US)

(21) Appl. No.: 12/115,478

(22) Filed: May 5, 2008

(51) Int. Cl. H02J 1/00

(52) U.S. Cl. 307/104

(57) ABSTRACT

Wireless power is used to deliver power to different areas on a circuit board or on an integrated circuity. The power can be delivered by magnetic resonant power or by inductive power coupling. Optical isolation can be used between different stages.

Our previous applications and provisional applications, including, but not limited to, U.S. patent application Ser. No. 12/018,069, filed Jan. 22, 2008, entitled “Wireless Apparatus and Methods”, the disclosure of which is herewith incorporated by reference, describe wireless transfer of power.

The transmit and receiving antennas disclosed in those applications are preferably resonant antennas, which are substantially resonant, e.g., within 10% of resonance, 15% of resonance, or 20% of resonance.

One embodiment uses an efficient power transfer between two antennas and circuits by storing energy in the near field of the transmitting antenna, rather than sending the energy into free space in the form of a travelling electromagnetic wave. This embodiment increases the quality factor (Q) of the antennas. This can reduce radiation resistance (Rᵣ) and loss resistance (Rₗ).

In one embodiment, two high-Q antennas are placed such that they react like a loosely coupled transformer, with one antenna inducing power into the other. The antennas preferably have Qs that are greater than 1000.

Our previous patent applications have described using this power to power or charge a load, for example a cellular phone or computer items on a desktop. However, the inventor noticed that other applications of wireless power delivery may also be possible.

### SUMMARY

The inventor noticed that electronic boards and components are often constrained and limited by their geometry—and that the geometry affects the ability to send and distribute power around to the different areas of the device.

For example, many multi-layer boards have extra levels that are used primarily or partly to deliver adequate power and ground to the different powered elements on the circuit board. In addition, the delivery of the power and ground itself causes problems. The delivery may cause so-called ground loops, that may contribute to problems within the powered circuits. Different parts of the circuit may need to be isolated from other parts of the circuit, especially if some circuit element causes power surges or other kinds of noise.

In recognition of this and other problems, the present application describes power delivery to electronic components on a substrate, e.g., circuit components, using wireless power techniques.

A first embodiment uses magnetic resonance to deliver power wirelessly at a distance. Other embodiments use other power delivery techniques such as inductive techniques to deliver the power.

One realization by the present inventor is that the power delivery will be over the space of inches and over fixed geometries and distances. The magnetic resonance power delivery system described in our co-pending applications may produce very good coupling efficiency over these small distances and fixed geometrical characteristics. In addition, since the geometry of the elements is always fixed, the receiver can be well tuned to the transmitter, thereby producing excellent coupling efficiency. For example, the coupling efficiency may be over 60%, or in some systems, over 90%.

A first embodiment may use this system for delivery to different areas on a circuit board. Each of a plurality of different areas may have its own power delivery mechanism. Each power delivery area may be electrically isolated from the other areas that receive power, and each may separately receive the power. Alternatively, of the areas may be electrically connected to one another, and power may be separately delivered to each of these areas.

Another embodiment may deliver power within an integrated circuit, for example a microprocessor or a VLSI chip. Many of these integrated circuits use many different layers in order to properly route the power. Since integrated circuits typically have a size of 1-2 cm, the wireless power delivery can be very efficient.

### BRIEF DESCRIPTION OF THE DRAWINGS

In the drawings:

FIG. 1 shows a prior art system;

FIG. 2 shows a first embodiment where power is delivered to areas of the circuit board; and

FIG. 3 shows a second embodiment where power is delivered within an integrated circuit.

### DETAILED DESCRIPTION

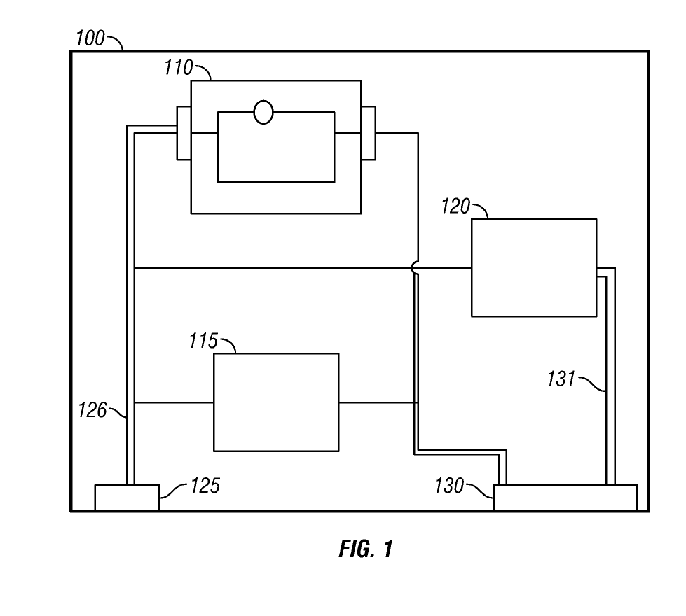

FIG. 1 shows a prior art system, and many of the problems that may be raised by this kind of electronic packaging.

Many circuit boards such as 100 include a number of different power consuming elements 110, 115, 120 associated therewith. While FIG. 1 shows only a single such device, a more realistic circuit board may have hundreds of devices.

The power is delivered from a set of power pins shown as 125, and ground is connected to ground pins 130. There is often a power and ground bus distributed across different locations throughout the circuit board. For example, ground bus 131 is connected to the ground end, while the power bus 126 is connected to the power pins 125.

In order to properly route the ground and power to different locations throughout the board, it is very often necessary to perform complicated board layout strategies, including routing over multiple layers. Moreover, it is important that the ground and power buses be of sufficient size so that there are minimal voltage drops along those power buses.

Power delivery is often the most complicated part of a board's layout.

Analogous issues are raised by power delivery within an integrated circuit. For example, the integrated circuit 110 itself may have layers that facilitate power delivery within the layers of the integrated circuit.

However, the inventor found that wireless delivery of power may be an excellent way to avoid many of these issues. For example, when power is delivered wirelessly within a fixed geometry system, e.g., a circuit board, the different elements including coils and capacitors can be precisely tuned, exactly to the precise geometry of the circuit board, this can produce very high coupling. In addition, this may reduce the complexity and clutter caused by power and ground lines extending throughout the device.

An additional aspect is that each area which separately receives power is itself inherently isolated from other areas. This may provide the desirable function of maintaining isolation between different items within the circuitry.

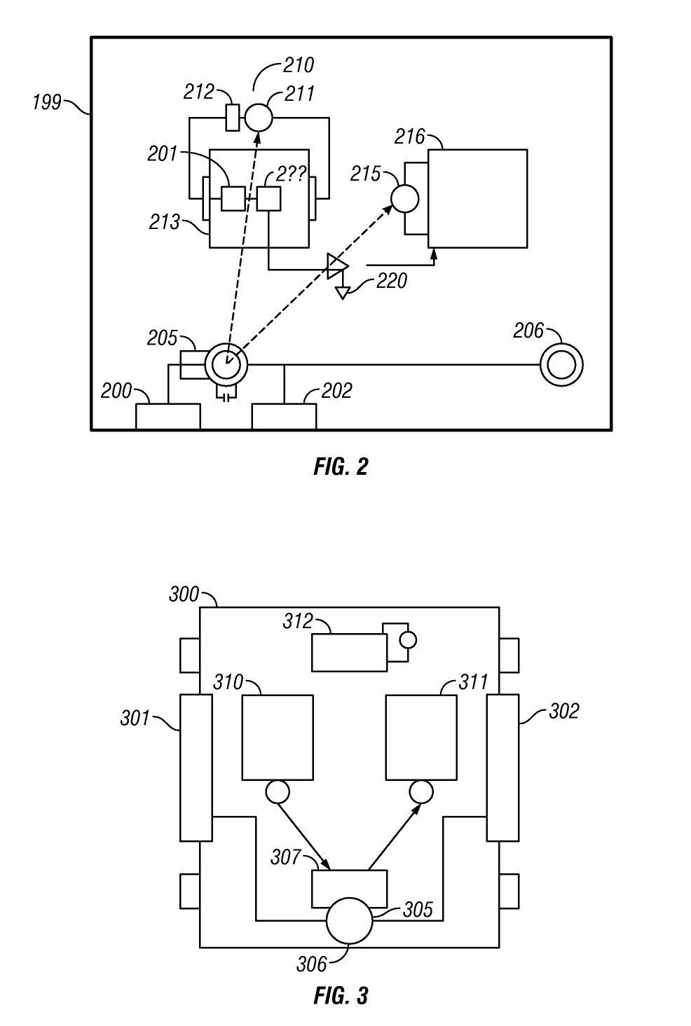

FIG. 2 illustrates a circuit board 205. A power pin 200 receives power and a ground pin 202 receives ground. The power and ground drives a wireless power transmitter assembly 205 which may be of the type described in application Ser. No. 12/040,783.

In one embodiment, the area of the transmitting antenna may be matched to the area of the receiving antenna and the entire system may be tuned for efficiency of coupling the power to the load.

A number of receiving structures 210, 215 are provided coupled to the surface of the board 199. Each of the receiving structures receives power wirelessly. Two different structures are shown, but it should be understood that there can be hundreds of different receiving structures. Each receiving structure such as 210 includes, for example, a series resonant antenna 211 formed of an inductor and capacitor, having an RC value optimized for a Q of at least 1000. A power circuit 212 that may for example rectify the power received by the receiving circuit 211. The output power is sent to a powered area 213. Powered area 213 may have one or more powered elements such as integrated circuits therein. For example, area 213 is shown with two integrated circuits 201, 202. Alternatively, each integrated circuit may have its own individual powering element, or the powering element may itself be built into the integrated circuit.

A signal output from the integrated circuit 202 in powered area 213, is sent to a signal input to a different powered area 216, which separately receives power from the antenna 215. In this embodiment, an optical isolator 220 may isolate the signal from the powered area 213 from the signal used in the powered area 216. In a similar way, there may be many other circuits, whose outputs may be directly connected, or may be optically isolated from one another.

This system has a number of advantages, disclosed herein. One such advantage is, as described above, the simplified geometry caused by the simplification of obtaining power.

In addition, however, the isolation of the different stages may be useful.

Moreover, since this system uses a completely fixed geometry, the placement, size and location of the transmitting antenna 205 may be optimally placed and tuned for efficiency in wireless power transfer.

In addition, for example, there may be a second transmitting antenna shown as 206, in a different location. Multiple different transmitting antennas may be especially useful when inductive coupling is used.

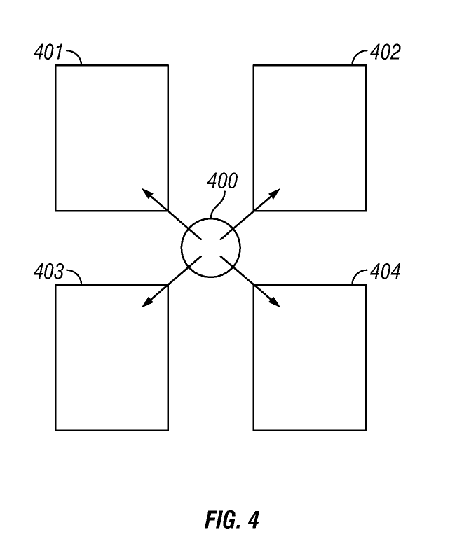

Another embodiment, shown in FIG. 3, carries out a similar operation within the packaging of an integrated circuit. The integrated circuit 300 is shown with a number of different pins receiving signal and power. The power pins 301, 302 are connected to a wireless power transmitter 305 which includes an antenna 306 and a power converter module 307. This may be centrally located within the chip, or may be located at any other location within the chip that is found to be optimal for delivering power to the fixed geometry of the chip. This power transmitter may wirelessly transmit power to all the other areas on the chip, for example area 310, area 311 and area 312. Each of these areas may include their own antenna to individually receive the power.

This power delivery system can be used on any kind of chip, for example a microprocessor or the like. Since the area of the chip is very small and this is a fixed geometry, very high efficiencies can be obtained by this system. As in the other systems, this may use optoisolation between stages if desired. As an alternative, the different stages may be connected together, in an attempt to even the power received by the different stations.

A disclosed system shows the power transmitter being within the substrate, for example FIG. 2 shows the power transmitter being on the board and FIG. 3 shows the power transmitter being on the IC. However, the power transmitter may be located remotely from the substrate. For example, a global power transmitter may transmit power to a number of different chips. One example of this may be as shown in FIG. 4, in which a global power transmitter 400 transmits power wirelessly to each of a plurality of chips 401, 402, 403, 404 that are surrounding transmitter 400.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of power transfer can be used.

Also, the inventors intend that only those claims which use the words “means for” are intended to be interpreted under USC 112, sixth paragraph. Moreover, no limitations from the specification are intended to be read into any claims, unless those limitations are expressly included in the claims. The computers described herein may be any kind of computer.

What is claimed is:

1. An electronic system comprising:
a substrate, having a plurality of power consuming elements thereon, said power consuming elements arranged in a fixed geometry on said substrate, and at least a plurality of said power consuming elements including a wireless power receiving part, that wirelessly receives power that is sent thereto, and uses said power which is wirelessly received, to power said power consuming elements, wherein at least one of said power consuming elements receives power separately from at least another of said power consuming elements, and wherein each of said power consuming elements operates substantially simultaneously, and wherein at least one of said power consuming elements has an output connected to another of said power consuming elements.

2. An electronic system as in claim 1, wherein said substrate is printed circuit board.

3. An electronic system as in claim 1, wherein said substrate is a substrate of an integrated circuit.

4. An electronic system as in claim 1, wherein said wireless power receiving element is associated with plural different power consuming elements, forming a group, and another wireless power receiving element is associated with different power receiving elements forming a second group.

5. An electronic system as in claim 1, further comprising an optical isolator, operating between different power receiving elements to allow signals to be connected therebetween.

6. A pen electronic system as in claim 1, wherein said wireless power receiving element is an element that receives power by magnetic resonance.

7. An electronic system as in claim 1, wherein said wireless power receiving element is an element that receives power by inductive power coupling.

8. An electronic system as in claim 1, further comprising a wireless power transmitting part, associated with said electronic system.

9. An electronic system as in claim 8, wherein said wireless power transmitting part is located on said substrate.

10. An electronic system as in claim 8, wherein said wireless power transmitting part is located off of said substrate but adjacent thereto.

11. A method comprising:
delivering power wirelessly to a plurality of different power consuming elements on a substrate, including delivering first power to a first element, and delivering second power to a second element, where the first power is separately delivered from the first power.

12. A method as in claim 11, further comprising optically isolating between said first element and said second element.

13. A method as in claim 11, wherein said substrate is printed circuit board.

14. A method as in claim 11, wherein said substrate is a substrate of an integrated circuit.

15. A method as in claim 11, wherein said delivering comprises delivering power by magnetic resonance.

16. A method as in claim 11, wherein said delivering comprises delivering power by inductive power coupling.

17. A method as in claim 11, wherein said delivering comprises delivering power from a power delivery part located on said substrate.

18. A method as in claim 11, wherein said delivering comprises delivering power from a power delivery part located off said substrate.

19. An electronic system comprising:
a substrate, having a plurality of power consuming elements thereon, and at least a plurality of said power consuming elements including a wireless power receiving part, that includes an inductive coil and a capacitor, forming an RC circuit with a first resonance property and a Q of at least 1000, and uses said power which is wirelessly received to power said power consuming elements, wherein at least one of said power consuming elements receives power separately from at least another of said power consuming elements, and wherein each of said power consuming elements operates substantially simultaneously.
